(19) United States
(12) Patent Application Publication
(10) Pub. No.: US 2004/0232842 A1
(43) Pub. Date: Nov. 25, 2004

(54) Plasma display unit

(76) Inventor: Hajime Inoue, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/484,625

(22) PCT Filed: Aug. 30, 2002
(86) PCT No.: PCT/JP02/08771

(30) Foreign Application Priority Data
Aug. 31, 2001 (JP) 2001-264411

(51) Int. Cl. H01J 17/49

(52) U.S. Cl. 313/584; 313/582

(57) ABSTRACT

Provided is a plasma display apparatus capable of being manufactured with higher light emission efficiency and higher yield. A bus electrode (18) is formed astride a region where a sustain electrode (37) is formed and a region on a front glass substrate (11) except for the region where the sustain electrode (37) is formed with an edge of the sustain electrode (37) on a side opposite to a side where the sustain electrode (37) is paired with another sustain electrode (37) in between. The bus electrode (18) has a shape expanding the whole width without widely coating the sustain electrode (37), so a cross-sectional area of the bus electrode (18) can be larger more than previously possible. An end portion of the sustain electrode (37) in a longitudinal direction has a forward tapered shape in which a side surface of the sustain electrode (37) forms an acute angle with the front glass substrate (11), so a step can be eliminated.

### TECHNICAL FIELD

The present invention relates to a plasma display apparatus performing display by use of a plasma discharge.

### BACKGROUND ART

A Plasma display panel (PDP) displays an image through applying vacuum ultraviolet rays generated by a gas discharge to a phosphor so as to emit light, and it has been expected that the plasma display panel will create a market for a low-profile and big-screen display.

FIG. 9 shows a schematic view of a conventional color plasma display apparatus, and FIG. 10 shows an enlarged partial view of a part in the vicinity of a sustain electrode on a side closer to a front glass substrate. A plasma display apparatus 100 has a structure in which a front glass substrate 101 disposed on a side closer to a display surface and a rear glass substrate 102 face each other, and are hermetically sealed at their edge portions so that an internal discharge space therein is filled with a discharge gas. On the front glass substrate 101, a pair of linear-shaped sustain electrodes 107 (107X, 107Y) are disposed in parallel with each other with a discharge gap in between, and a dielectric layer 109 and a protective layer 110 made of a magnesium oxide (MgO) film are disposed in order on the sustain electrodes 107. On the other hand, on the rear glass substrate 102, a large number of linear-shaped address electrodes 103 are disposed in parallel with one another, and a dielectric layer 104 and barrier ribs 105 extending in stripes are disposed in order on the address electrodes 103. The discharge space is divided per address electrode 103 by the barrier ribs 105, and three primary color phosphors 106 of red (R), green (G) and blue (B) are periodically disposed on portions of the barrier ribs 105 and the dielectric layer 104 which face the discharge space. Further, the address electrodes 103 (and the barrier ribs 105) are arranged in a matrix orthogonal to the sustain electrodes 107.

The sustain electrodes 107 are made of a transparent electrode material such as ITO (indium-tin oxide) in order to improve light extraction efficiency of the display surface. Such transparent electrode material has high resistance, so in many cases, as shown in FIG. 10, a bus electrode 108 made of an electrically conductive material with low resistance is partially laminated on a surface of each of the sustain electrodes 107 so as to reduce the resistance. More specifically, the bus electrode 108 is made of an Al thin film, a Cr/Cu/Cr film or the like, which is a non-translucent material with low resistance, in contrast to the sustain electrode 107, so the bus electrode 108 is formed on a side of the sustain electrode 107 opposite to a side closer to the discharge gap.

In order to improve light emission efficiency while reducing electrode resistance, a certain extent of cross-sectional area of the bus electrode 108 is required. Therefore, in order to have a larger cross-sectional area of the bus electrode 108 without declining the light extraction efficiency, the bus electrode 108 is designed so as to increase its thickness as large as possible instead of its width.

However, when the bus electrode 108 has a large thickness, the following problems occur, so there is a limit on increasing the thickness. Firstly, as adhesion of the bus electrode 108 declines due to stress or the like, the electrode resistance may increase correspondingly. Secondly, when the dielectric layer 109 is formed on the bus electrode 108 through printing or the like, a large fold F is formed around a step formed by the bus electrode 108 (refer to FIG. 10), so adhesion of a portion around the fold F declines so that peeling may occur, or air bubbles may be formed in a step portion of the dielectric layer 109 to be formed. Peeling and air bubbles cause a decline in pressure resistance of the dielectric layer 109 to a discharge gas, thereby resulting in a reduction in manufacturing yield.

In view of the foregoing, it is an object of the invention to provide a plasma display apparatus capable of being manufactured with higher light emission efficiency and higher yield.

### DISCLOSURE OF THE INVENTION

In a plasma display apparatus according to the invention, a bus electrode is formed astride a region including one surface of a sustain electrode and a region of a transparent substrate except for a region where the sustain electrode is formed with-one edge portion of the sustain electrode in a longitudinal direction in between.

In another plasma display apparatus according to the invention, a side surface of at least one of a sustain electrode or a bus electrode in a longitudinal direction is inclined at an acute angle with respect to a flat surface of a transparent substrate.

In the plasma display apparatus according to the invention, the bus electrode only partially comes into contact with the sustain electrode, so there is a space where the width of the bus electrode can be expanded more than previously possible, so the bus electrode can be formed with a thinner width while having a sufficiently large cross-sectional area.

In another plasma display apparatus according to the invention, the side surface of the sustain electrode or the bus electrode which forms an acute angle with the transparent substrate has no step, so the formation of air bubbles or peeling in a step portion of the bus electrode or a dielectric layer formed on the side surface can be reduced.

### BRIEF DESCRIPTION OF THE DRAWINGS

FIG. 1 is a schematic perspective view of a plasma display apparatus according to a first embodiment of the invention;

FIGS. 2A and 2B are illustrations showing a structure of a main part of the plasma display apparatus shown in FIG. 1, and are a sectional view and a plan view, respectively;

FIG. 3 is an illustration for describing a forming position of a bus electrode in the plasma display apparatus shown in FIG. 1;

FIGS. 4A through 4C are illustrations showing a driving sequence of the plasma display apparatus shown in FIG. 1;

FIGS. 5A and 5B are illustrations showing a structure of a main part of a plasma display apparatus according to a second embodiment of the invention, and are a sectional view and a plan view, respectively;

FIG. 6 is an enlarged view of an electrode portion of the plasma display apparatus shown in FIG. 5A;

FIGS. 7A and 7B are illustrations showing a structure of a main part of a plasma display apparatus according to a third embodiment of the invention, and are a sectional view and a plan view, respectively;

FIG. 8 is an enlarged partial view for describing a shape of a bus electrode in the plasma display apparatus shown in FIG. 7A;

FIG. 9 is a perspective view showing a basic structure of a conventional plasma display apparatus; and

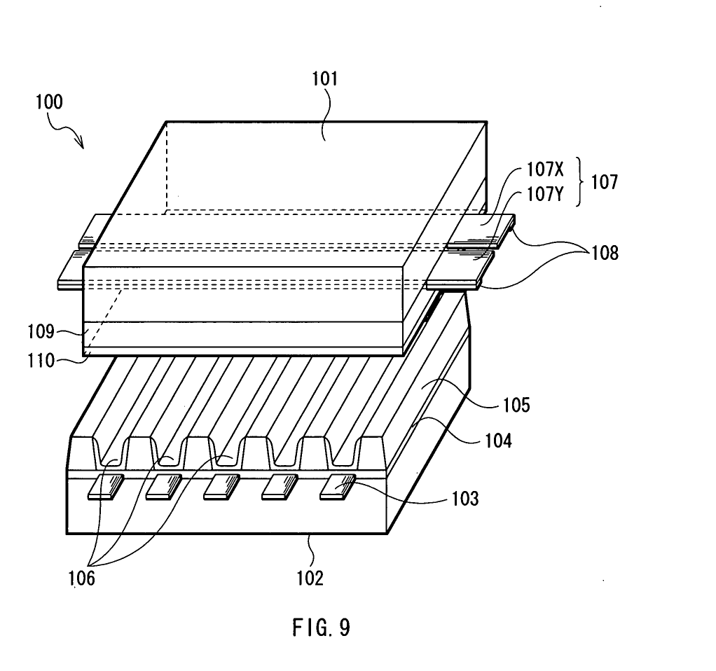

FIG. 10 is an illustration for describing a position of a bus electrode in the conventional plasma display apparatus shown in FIG. 9.

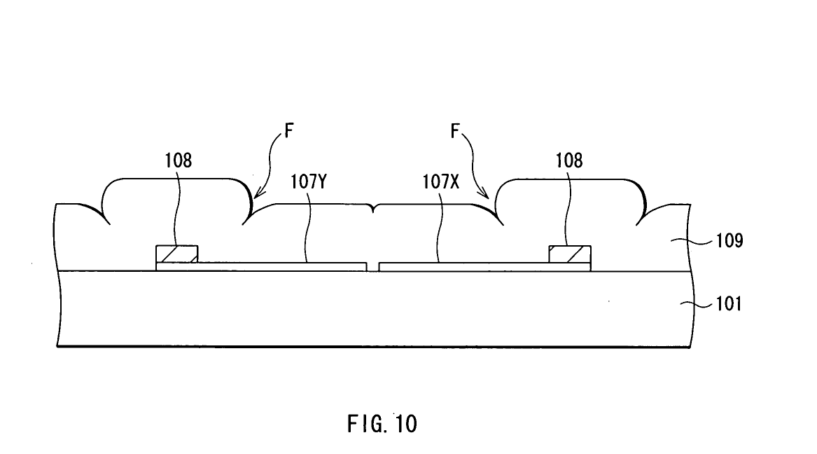

### BEST MODE FOR CARRYING OUT THE INVENTION

Preferred embodiment of the present invention will be described in more detail below referring to the accompanying drawings.

### First Embodiment

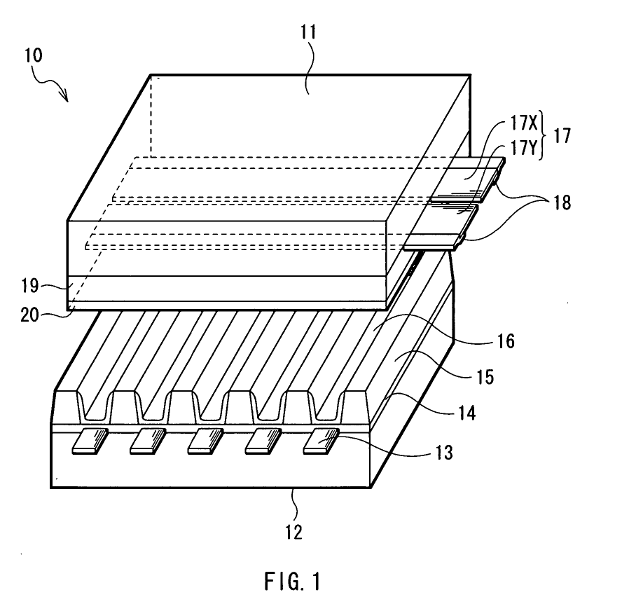

FIG. 1 shows a schematic view of a plasma display apparatus according to a first embodiment of the invention. The structure of the plasma display apparatus is equivalent to that of a conventional plasma display apparatus 100 except that the shape of a bus electrode 18 and a position of the bus electrode 18 in relation to a sustain electrode 17 are different.

A front glass substrate 11 positioned on a side closer to a display surface is required to be made of a high transparent material so that light generated in the plasma display apparatus passes through the front glass substrate 11 to be extracted to outside, and, for example, high strain point glass or soda-lime glass is used. On the front glass substrate 11, a pair of linear-shaped sustain electrodes 17 (17X, 17Y) are disposed in parallel with each other, and the bus electrode 18 for reducing resistance is disposed on one edge portion of each of the sustain electrodes 17 in a longitudinal direction. The sustain electrodes 17 are made of, for example, ITO which is a transparent electrode material, and the bus electrode 18 is made of, for example, a metal thin film such as a Mo/Al film, a Cr/Cu/Cr film or the like.

Moreover, the sustain electrodes 17 are disposed in parallel in a direction where the longitudinal directions of the sustain electrodes 17 are orthogonal to a longitudinal direction of an address electrode 13 on a side closer to a rear substrate 12 when viewed from the side closer to the display surface, and the sustain electrodes 17 and the address electrode 13 form an electrode matrix. Each region formed by the pair of sustain electrodes 17 and the address electrode 13 disposed orthogonal to each other is a light emitting region corresponding to a pixel in the plasma display apparatus.

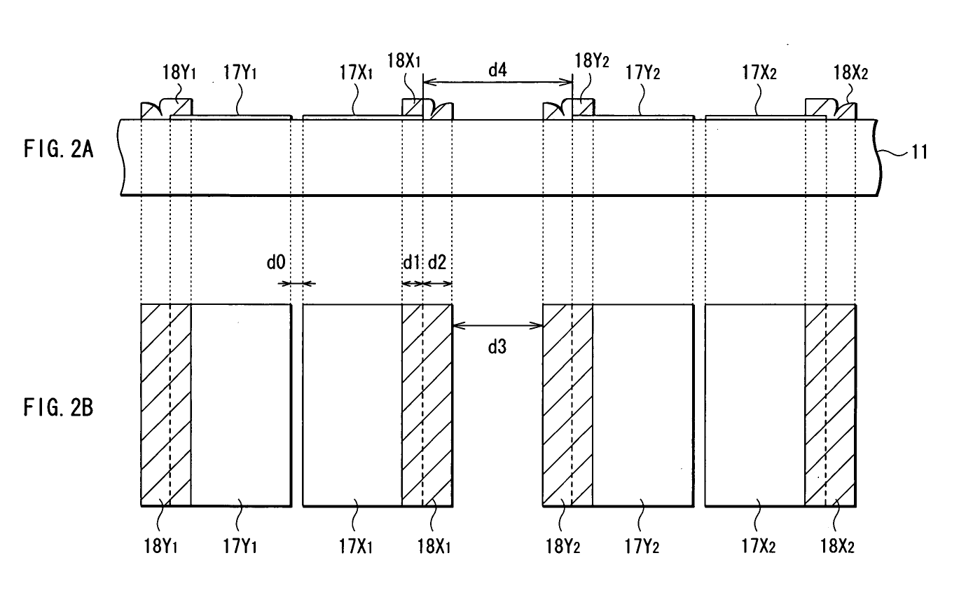

FIGS. 2A and 2B are illustrations showing a position of the bus electrode 18 in relation to the sustain electrode 17, and are a sectional view and a plan view, respectively. In the drawings, two pairs of sustain electrodes 17 (17X₁ and 17Y₁, 17X₂ and 17Y₂) adjacent to each other are shown, and each bus electrode 18 attached to each sustain electrode 17 is discriminated by a symbol ending in X₁, Y₁, X₂ or X₂ which indicates a position of each sustain electrode 17. Each bus electrode 18 has a portion with a width d1 and a portion with a width d2, and is formed astride a region where the sustain electrode 17 is formed (corresponding to the portion with the width d1) and a region of the front glass substrate 11 except for the region where the sustain electrode 17 is formed (corresponding to the portion with the width d2) with an edge portion of the sustain electrode 17 on a side opposite to a side where the pair of sustain electrodes 17 are paired with each other in between. Herein, a thickness or a width of the sustain electrode 17 is optionally determined, and has, for example, a dimension generally used. Further, a thickness or a width (d1, d2) of the bus electrode 18 is optionally determined. However, a space d3 between the bus electrode 18 and an adjacent bus electrode 18 on a side of an adjacent pair of sustain electrodes 17, that is, between the bus electrodes 18X₁ and 18Y₂ in FIGS. 2A and 2B must be as large as no discharge occurs at a voltage equal to or lower than a discharge voltage between a pair of sustain electrodes 17X and 17Y. In other words, when electricity is discharged between the pairs of sustain electrodes 17 (17X₁ and 17Y₁, 17X₂ and 17Y₂) with a space d0 in between, the space d3 between the bus electrodes 18X₁ and 18Y₂ is required to be determined so that no discharge occurs between the sustain electrodes 17X₁ and 17Y₂.

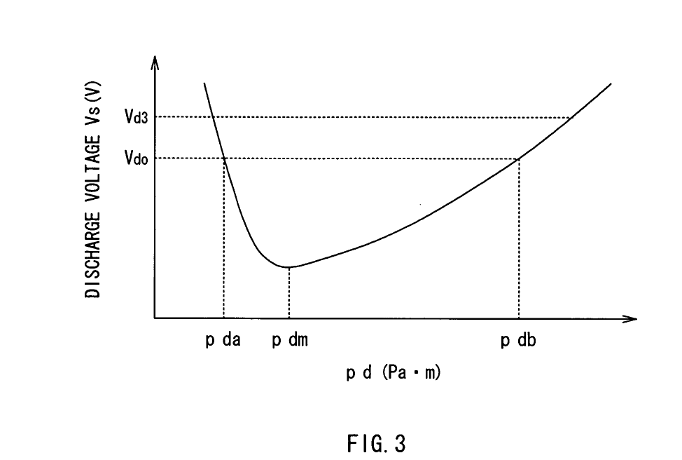

A discharge voltage Vs inducing a discharge between the sustain electrodes 17 has correlation shown in FIG. 3 in relation to the product (pd product) of a pressure p in a discharge space and a distance d between electrodes. In this case, the pressure p is uniform, so a lateral axis in FIG. 3 can be considered to correspond to the distance between the electrodes. In order to satisfying the above requirement, a discharge voltage V_{d3} in d3 is required to be higher than a discharge voltage V_{d0} in d0 (V_{d3}>V_{d0}), so in the drawing, d3 is determined so as to have the following relationship with d0.

Where d0=da or db, d3<da or d3>db (1)

Where d0=dm, d3γd0 (2)

When the space d3 and a space d4 between the sustain electrodes 17X₁ and 17Y₂ adjacent to each other on a side opposite to a side where the pair of sustain electrodes are paired with each other are determined, the width d2 of the bus electrode 18 is determined. When a value satisfying a formula (1) or a formula (2), and being as small as possible is chosen as d3, a value of the width d2 can be increased. Thus, the whole width of the bus electrode 18 can be expanded without widely coating the sustain electrode 17, and a cross-sectional area of the bus electrode 18 can be larger than previously possible.

Moreover, when the bus electrode 18 has poor transparency, which holds true in most cases in actuality, the bus electrodes 18X₁ and 18Y₂ adjacent to each other on a side opposite to a side where the bus electrodes 18X₁ and 18Y₂ are paired with the bus electrodes 18Y₁ and 18X₂, respectively are disposed between the light emitting regions aligned in a width direction of the sustain electrodes 17, and have a function of dividing into pixels to be displayed. In order to divide into pixels, in general, a black matrix is disposed so as to fill a space between the light emitting regions, on the other hand, in the embodiment, the bus electrodes 18 perform the function. Specifically, when the width d2 of the bus electrode 18 is expanded while reducing the space d3 as small as possible, the bus electrode 18 can improve contrast more effectively.

On the sustain electrodes 17 and the bus electrodes 18, a dielectric layer 19 made of, for example, SiO₂ is disposed, and on the dielectric layer 19, a protective layer 20 made of, for example, MgO is disposed.

On the other hand, the rear glass substrate 12 is made of, for example, the same material as that of the front glass substrate 11, and on the rear glass substrate 12, linear-shaped address electrodes 13 made of, for example, a metal thin film such as aluminum (Al) are disposed in parallel. Further, on the address electrodes 13, a dielectric layer 14 made of, for example, SiO₂ is disposed, and on the dielectric layer 14, barrier ribs 15 which divide the discharge space per address electrode 13 are disposed. Crosstalk of light emission between adjacent light emitting regions in a direction where the address electrodes 13 are aligned can be prevented by the barrier ribs 15. Further, three primary color phosphors 16 of red (R), green (G) and blue (B) are periodically disposed on portions of the barrier ribs 15 and the dielectric layer 14 which face the discharge space, and each light emitting region emits light corresponding to color arrangement.

Moreover, the front glass substrate 11 and the rear glass substrate 12 face each other with the discharge space in between, and are hermetically sealed with a spacer (not shown) in between at edge portions thereof. Further, in the discharge space, a discharge gas made of, for example, at least one noble gas selected from the group consisting of He, Ne, Ar, Xe and Kr is filled.

The plasma display apparatus can be manufactured through a conventional method except that a pattern of the bus electrode 18 is different. For example, the plasma display apparatus can be manufactured through the following steps.

At first, the front glass substrate 11 is prepared, and on the front glass substrate 11, for example, a film made of a transparent electrode material such as ITO is formed and patterned through sputtering or vacuum deposition so as to form a pair of sustain electrodes 17 in stripes. Then, the bus electrode 18 with a predetermined width is formed in a predetermined position on an edge portion of each of the sustain electrodes 17 on a side opposite to a side where a pair of sustain electrodes 17 are paired with each other. A single-layer film or a laminated film is formed of a good conductive metallic material of Ag, Al, Ni, Cu, Mo, Cr or the like such as, for example, Mo/Al so as to from the bus electrode 18. As a method of forming the film, screen printing, sputtering, vacuum deposition, CVD (chemical vapor deposition) or the like can be used.

After that, the dielectric layer 19 made of SiO₂ is formed through, for example, sputtering or screen printing, and on the whole surface of the dielectric layer 19, the protective layer 20 made of MgO is formed through electron beam evaporation.

Next, the rear glass substrate 12 is prepared, and on the rear glass substrate 12, for example, as in the case of the bus electrode 18, a good conductive metallic material, more specifically an alloy of Al and Mn is formed through patterning so as to form the address electrodes 13 in stripes. Next, for example, a film made of SiO₂ is formed through CVD or printing so as to form the dielectric layer 14. Then, glass paste is patterned in a predetermined region on the dielectric layer 14, and then the patterned glass paste is fired so as to form the barrier ribs 15 in a predetermined shape. More specifically, after low-melting glass in paste form is coated through screen printing, the low-melting glass is shaped into stripes through sandblasting, and then is fired. Next, for example, phosphor slurry is printed from side surfaces of the barrier ribs 15 adjacent to each other to the dielectric layer 14 sandwiched in between so as to form the phosphor 16 in a predetermined position.

Next, the front glass substrate 11 and the rear glass substrate 12 are assembled. For example, a seal layer made of low-melting glass is formed on an edge portion of the front glass substrate 11 through screen printing. After that, the front glass substrate 11 and the rear glass substrate 12 are bonded together so that the directions of the sustain electrodes 17 and the address electrodes 13 are orthogonal to each other, then the front glass substrate 11 and the rear glass substrate 12 are fired so as to fire and cure the seal layer. Further, air is exhausted from a discharge space disposed between two substrates 11 and 12 and divided by the barrier ribs 15, and a gas mixture is sealed in the discharge space. Thereby, the plasma display apparatus according to the embodiment is completed.

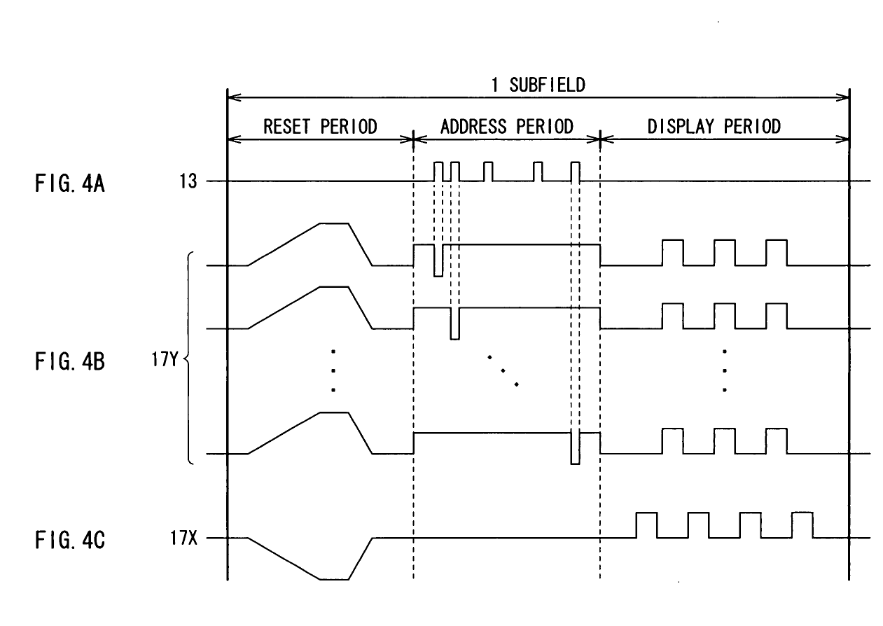

The plasma display apparatus can work, for example, as follow. FIGS. 4A through 4C show a driving sequence corresponding to 1 subfield per electrode. FIG. 4B shows a waveform of voltage inputted into each of a plurality of sustain electrodes 17Y, and waveforms of voltage inputted into the sustain electrodes 17X paired with the sustain electrodes 17Y are all the same, so only one of the waveforms is shown in FIG. 4C. One field of a display screen in a typical image display comprises subfields each having a weight, and gray scale display is performed by control of the subfields. Further, each subfield can be divided into three, that is, a reset period, an address period following the reset period, and a display period.

At first, a voltage is applied to all of the sustain electrodes 17X and 17Y during the reset period so as to carry out a preparatory discharge, a charge (wall charge) is uniformly created on the protective layer 20 in all of the light emitting regions. Next, when a driving voltage is applied to the sustain electrodes 17Y and the address electrodes 13 corresponding to pixels which are not intended to emit light so as to carry out an address discharge, the wall charge is selectively eliminated from light emitting regions of the pixels not intended to emit light. Thereby, the wall charge remains only in the position of a pixel intended to emit light so as to select a display pixel. Next, when an AC pulse driving voltage is applied between the sustain electrodes 17X and 17Y during the display period, in the light emitting region where the wall charge remains, a potential of the wall charge is superimposed on the pulse voltage, so the pulse voltage reaches a discharge start voltage between the sustain electrodes 17X and 17Y, thereby a discharge occurs. The discharge is a radio frequency discharge, and accumulation of charge is concurrently performed, so a discharge continuously occurs, therefore, a state of discharge can be sustained (sustain discharge). When ultraviolet rays emitted from a discharge gas by the discharge are applied to the phosphor 16, the phosphor 16 emits light so that a pixel corresponding to the light emitting region illuminates. Thus, the light emitting region selectively emits light so as to form a predetermined pattern in one subfield, and the subfields are superimposed in a time series, thereby an image of one field with a controlled gray scale is displayed.

As described above, according to the embodiment, the bus electrode 18 is formed in a shape having a portion with the width d2 extending off the sustain electrode 17 on the front glass substrate 11, so the whole width of the bus electrode 18 can be expanded without widely coating the sustain electrode 17, and a cross-sectional area of the bus electrode 18 can be larger than previously possible. By adding the bus electrode 18, resistance in the sustain electrode 17 can be reduced more than previously possible, thereby light emission efficiency of the plasma display apparatus can be improved. At the same time, the thickness of the bus electrode 18 can be reduced with a sufficient cross-sectional area, thereby in conjunction with an expanded width, adhesion to the sustain electrode 17 can be improved, and the resistance in the sustain electrode 17 can be effectively reduced.

Moreover, as the bus electrode 18 has a larger width than previously possible, and is formed on an end portion of each light emitting region, adjacent pixels are divided by the bus electrode 18 to be displayed, so contrast can be improved.

Further, the bus electrode 18 has a shape extending off the sustain electrode 17, so compared to a conventional case where the bus electrode 18 is formed so as to keep both end portions aligned, alignment accuracy during formation is less required. Further, as described above, the bus electrode 18 can have a thinner thickness by having a larger width than before, thereby adhesion can be improved. Therefore, manufacturing yield can be improved.

Still further, the space d₃ between the bus electrode 18X₁ and the bus electrode 18Y₂ is as large as no discharge occurs at a voltage equal to or lower than the discharge voltage V_{d0} in the space d0 between the sustain electrodes 17X and 17Y, so a discharge between the sustain electrodes 17X₁ and 17Y₂ can be prevented.

### Second Embodiment

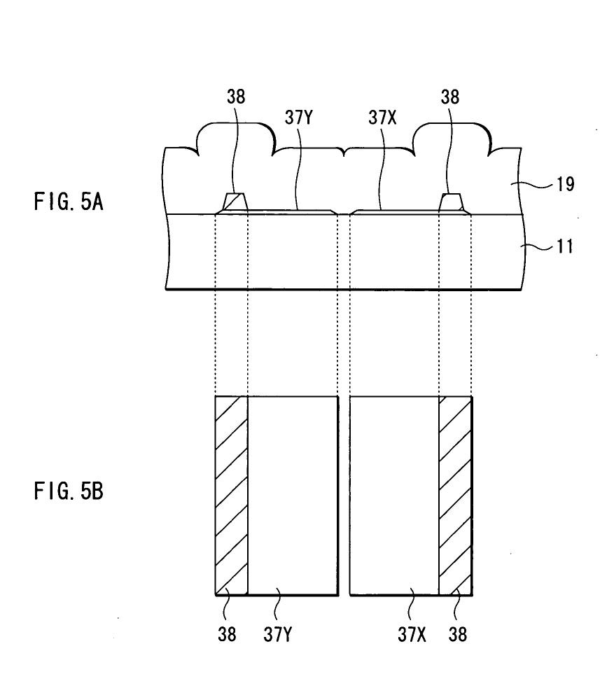

FIGS. 5A and 5B show a partial view of a main part of a plasma display apparatus according to a second embodiment of the invention, and are a sectional view and a plan view, respectively. The plasma display apparatus is equivalent to the plasma display apparatus according to the first embodiment except that a sustain electrode 37 and a bus electrode 38 have different shapes. In the following embodiments, like components are denoted by like numerals as of the first embodiment and will not be further explained.

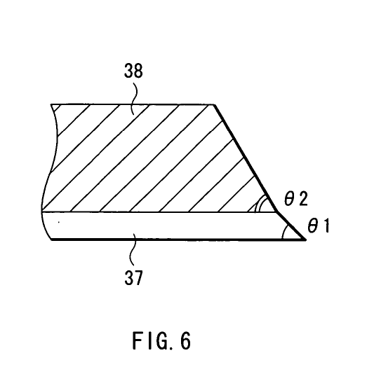

In the second embodiment, as shown in an enlarged view of FIG. 6, a side surface of the sustain electrode 37 and a side surface of the bus electrode 38 in a longitudinal direction forms angles θ1 and θ2, which are acute, with respect to the front glass substrate 11, respectively. In general, the shape of a part where a side surface is inclined not at a right angle but at an angle θ is called a tapered shape, and when the angle θ is acute as in the case of the embodiment, it is called a forward tapered shape. The sustain electrode 37 (37X, 37Y) has the same shape as the sustain electrode 17 in the first embodiment except for an end portion with a forward tapered shape in a longitudinal direction, and is disposed in the same manner as the sustain electrode 17 of the first embodiment. The bus electrode 38 is distinguished from the bus electrode 18 by the fact that an end portion in a longitudinal direction has a different shape, and the bus electrode 38 is disposed only on the sustain electrode 37.

When the end portions of the sustain electrode 37 and the bus electrode 38 in a longitudinal direction have a forward tapered shape, a step on side surfaces thereof is small, so peeling or the formation of air bubbles in a step portion of the dielectric layer 19 formed on the step can be reduced. In order to flatten the step portion more, the tapered angles θ1 and θ2 of the sustain electrode 37 and the bus electrode 38, respectively, are preferably smaller, more preferably 45° or less.

The end portions of the sustain electrode 37 and the bus electrode 38 can be processed in a forward tapered shape through, for example, anisotropic etching by dry etching. The sustain electrode 37 made of ITO is preferably etched by using a gas of HCl, C1₂, HF or HBr, or a gas mixture thereof at a high frequency of 400 kHz or over and a pressure of 1 Pa to 5 Pa. Further, the bus electrode 38 made of Al is preferably etched by ICP (inductively coupled plasma) using a gas of BCl₃, C1₂ or the like at a pressure of 4 Pa. Alternatively, a material with a high etching rate is coated on a surface of the sustain electrode 37 or the bus electrode 38, and a resist is formed on the coated material, then wet etching using HCl is carried out, thereby a portion close to the surface is etched earlier, so the end portion can be processed in a substantially forward tapered shape.

Thus, according to the embodiment, the angles 01 and 02 which the side surfaces of the sustain electrode 37 and the bus electrode 38 form with the front glass substrate 11, respectively, are acute, peeling or the formation of air bubbles in the step portion of the side surface of the dielectric layer 19 can be reduced, so the adhesion and pressure resistance of the dielectric layer 19 can be improved. Therefore, the manufacturing yield can be improved.

Moreover, when the step on the surfaces of the electrodes 37 and 38 is eliminated, a dielectric film can be used to form the dielectric layer 19. In this case, a dielectric in film form is stuck so as to form the dielectric layer 19. Conventionally, the adhesion of the film to the step portion is not sufficient, so it is difficult to use the film, however, in the embodiment, the dielectric layer 19 in film form can be adhered to the side surfaces of the electrodes 37 and 38, so the dielectric layer 19 with good adhesion can be easily formed.

### Third Embodiment

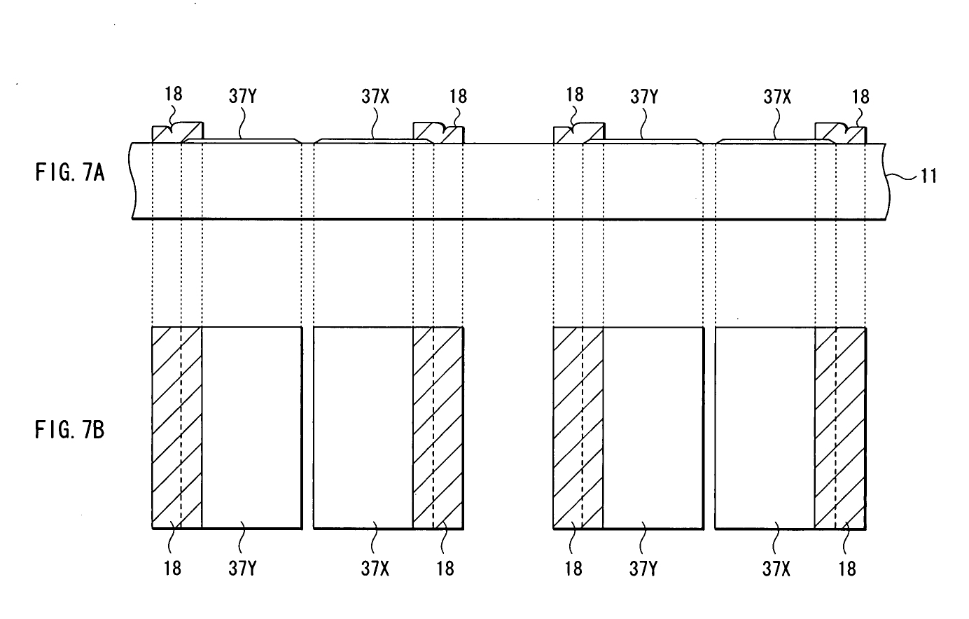

FIGS. 7A and 7B show partial views of a main part of a plasma display apparatus according to a third embodiment of the invention, and are a sectional view and a plan view, respectively. In the plasma display apparatus, the bus electrode 18 of the first embodiment is formed on the sustain electrode 37 of the second embodiment.

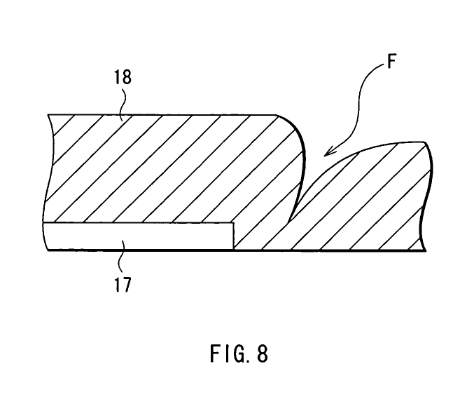

In the third embodiment, the bus electrode 18 is formed astride a region including a surface of the sustain electrode 37 and a region of the front glass substrate 11 except for a region where the sustain electrode 37 is formed with the side surface of the sustain electrode 37 which forms the acute angle θ1 with the front glass substrate 11 in between. When the end portion of the sustain electrode 37 has a step, the bus electrode 18 tends to form the fold F shown in FIG. 8 in the step portion thereof. The thickness of the bus electrode 18 at the fold F is thinner, so a so-called “step-cut” may occur in the bus electrode 18, and a corner portion of the sustain electrode 37 and its surroundings may generate heat. On the contrary, in the embodiment, the side surface of the sustain electrode 37 is inclined so as to flatten a portion where a step is disposed, so the bus electrode 18 is formed on the portion with a more uniform thickness than before to prevent the step-cut. Further, as in the case of the dielectric layer 19 described in the second embodiment, peeling and the formation of air bubbles in the bus electrode 18 can be reduced.

Moreover, in the sustain electrode 37, the other end portion on a side where the sustain electrode 37 is paired with another sustain electrode 37 is formed in a forward tapered shape, so peeling or the formation of air bubbles in the dielectric layer 19 formed on the sustain electrode 37 can be reduced.

Thus, according to the embodiment, the angle θ1 which the side surface of the sustain electrode 37 forms is acute, so the end portion of the sustain electrode 37 is flattened, thereby the step-cut around the end portion of the sustain electrode 37 in the bus electrode 18 can be prevented, and a large effect of reducing the resistance to the sustain electrode 37 can be stably exerted. At the same time, the end portion of the sustain electrode 37 has a forward tapered shape so that the step portion thereof is flattened, so peeling or the formation of air bubbles in the bus electrode 18 and the dielectric layer 19 can be reduced, thereby adhesion and pressure resistance can be improved, and the plasma display apparatus can be manufactured with higher manufacturing yield.

Moreover, when a step on the side surface of the sustain electrode 37 is eliminated, the bus electrode 18 with good adhesion can be easily formed by using a film of Ag or the like. Other effects are equivalent to those in the first embodiment.

The present invention is not limited to the above-described embodiments, and can be variously modified. For example, in the third embodiment, only the sustain electrode 37 has the end portion with a forward tapered shape, but an end portion of the bus electrode 18 can have a forward tapered shape. In this case, as described in the second embodiment, adhesion and pressure resistance of the dielectric layer 19 formed on the bus electrode 18 can be improved. Further, both end portions of the sustain electrode 37 or the bus electrode 38 in a longitudinal direction are not necessarily formed in a forward tapered shape. For example, in the sustain electrode 37 of the third embodiment, only one end portion where the bus electrode 38 is formed may have a forward tapered shape.

Moreover, according to the embodiments, the sustain electrode 17 or 37 is formed directly on the front glass substrate 11, and on the sustain electrode 17 or 37, the bus electrode 18 or 38 are formed. However, the sustain electrode and the bus electrode are not required to come into contact with the substrate. For example, they may be formed on the dielectric layer. The invention is widely applicable to a structure that the sustain electrode and the bus electrode partially come into contact with each other. For example, the bus electrode may be formed closer to the front glass substrate than the sustain electrode.

As described above, according to the plasma display apparatus of the invention, the bus electrode is formed astride a region including one surface of the sustain electrode and a region of a transparent substrate except for a region where the sustain electrode is formed with one edge portion of the sustain electrode in a longitudinal direction in between, so the whole width of the bus electrode can be expanded without coating a larger portion of the sustain electrode than necessary, thereby the cross-sectional area of the bus electrode can be larger than previously possible. Therefore, by adding the bus electrode, the resistance in the sustain electrode can be more effectively reduced than previously possible, and light emission efficiency can be improved without reducing light extraction efficiency. Further, adjacent pixels are divided by the bus electrode to be displayed, so contrast can be improved. Still further, the bus electrode is formed so as to extend off the sustain electrode, so lower alignment accuracy is required, and the bus electrode can be easily formed.

According to another plasma display apparatus of the invention, a side surface of at least one of the sustain electrode or the bus electrode in a longitudinal direction is inclined so that an angle which the side surface forms with a flat surface of the transparent substrate is acute, so peeling or the formation of air bubbles in a step portion of each layer formed on the side surface can be reduced, thereby the adhesion and pressure resistance of each layer formed on the side surface can be improved. Further, as the step on the sustain electrode is eliminated, the bus electrode formed so as to extend off the sustain electrode can be formed with a more uniform thickness, therefore, the occurrence of a step-cut or heat generation can be prevented. Therefore, the manufacturing yield can be improved.

Obviously many modifications and variations of the present invention are possible in the light of the above teachings. It is therefore to be understood that within the scope of the appended claims the invention may be practiced otherwise than as specifically described.

1. (cancel)

2. (cancel)

3. (cancel)

4. A plasma display apparatus, comprising:
a transparent substrate having a flat surface;
a plurality of pairs of linear-shaped sustain electrodes being formed in parallel with each other on one surface of the transparent substrate;
a plurality of bus electrodes each being disposed so as to come into contact with each of the sustain electrodes; and
a dielectric layer coating the sustain electrodes and the bus electrodes,
wherein a side surface of at least one of each of the sustain electrodes or each of the bus electrodes in a longitudinal direction is inclined at an acute angle with respect to the flat surface of the transparent substrate.

5. A plasma display apparatus according to claim 4, wherein
a side surface of each of the sustain electrodes on a side in contact with each of the bus electrodes is inclined at an acute angle with respect to the flat surface of the transparent substrate.

6. A plasma display apparatus according to claim 4, wherein
an angle which the side surface forms with the flat surface of the transparent substrate is 45° or less.
